(19) United States
(12) Patent Application Publication
(10) Pub. No.: US 2016/0337596 A1
(43) Pub. Date: Nov. 17, 2016

(54) ELECTRONIC DEVICE, CONTROL METHOD, AND CONTROL PROGRAM

(71) Applicant: KYOCERA Corporation, Kyoto-shi (JP)

(72) Inventors: Saya MIURA, Yokohama-shi (JP); Shinya MIZUNO, Tokyo (JP)

(21) Appl. No.: 15/151,498

(22) Filed: May 11, 2016

(30) Foreign Application Priority Data
May 12, 2015 (JP) 2015-097771

(51) Int. Cl. H04N 5/232; G01L 9/00; H04N 5/225

(52) U.S. Cl. CPC H04N 5/23293; H04N 5/2257; G01L 9/0001

(57) ABSTRACT

In some embodiments, an electronic device includes an imaging device, a display configured to display an image acquired by the imaging device, a sensor configured to measure information that is used to detect a change in a surrounding environment of the electronic device, and at least one controller configured to determine the surrounding environment continuously based on a measurement result of the sensor to switch an operational setting related to an operation of the imaging device and a setting related to automatic correction of the image acquired by the imaging device, based on a determination result of the surrounding environment, when the change in the surrounding environment is detected. The at least one controller switches the setting related to the automatic correction, when the imaging device has already started capturing a moving image when the change in the surrounding environment is detected, without switching the operational setting.

### CROSS-REFERENCE TO RELATED APPLICATION

The present application claims priority to and incorporates by reference the entire contents of Japanese Patent Application No. 2015-097771 filed in Japan on May 12, 2015.

### BACKGROUND

1. Field

The present application relates to an electronic device, a control method, and a control program.

2. Description of the Related Art

A known conventional own device changes, upon detecting water attached to an display surface, manners of displaying information on the display surface (for example, refer to Japanese Laid-open Patent Publication No. 2012-123740).

There is still a room for improving the method of switching a user interface, when a conventional electronic device is capturing moving images.

### SUMMARY

It is an object of embodiments to at least partially solve the problems in the conventional technology.

According to one aspect, there is provided an electronic device, comprising: an imaging device; a display configured to display an image acquired by the imaging device; a sensor configured to measure information that is used to detect a change in a surrounding environment of the electronic device; and at least one controller configured to determine the surrounding environment continuously based on a measurement result of the sensor to switch an operational setting related to an operation of the imaging device and a setting related to automatic correction of the image acquired by the imaging device, based on a determination result of the surrounding environment, when the change in the surrounding environment is detected, wherein the at least one controller is configured to switch the setting related to the automatic correction, when the imaging device has already started capturing a moving image at a point when the change in the surrounding environment is detected, without switching the operational setting.

According to one aspect, there is provided a control method executed by an electronic device including an imaging device, a display configured to display an image acquired by the imaging device, and a sensor configured to measure information that is used to detect a change in a surrounding environment of the electronic device, the control method comprising: determining the surrounding environment continuously based on a measurement result of the sensor to switch an operational setting related to an operation of the imaging device and a setting related to automatic correction of the image acquired by the imaging device, based on a determination result of the surrounding environment, when the change in the surrounding environment is detected; and switching the setting related to the automatic correction, when the imaging device has already started capturing a moving image at a point when the change in the surrounding environment is detected, without switching the operational setting.

According to one aspect, there is provided a non-transitory storage medium that stores a control program for causing, when executed by an electronic device including an imaging device, a display configured to display an image acquired by the imaging device, and a sensor configured to measure information that is used to detect a change in a surrounding environment of the electronic device, the electronic device to execute: determining the surrounding environment continuously based on a measurement result of the sensor to switch an operational setting related to an operation of the imaging device and a setting related to automatic correction of the image acquired by the imaging device, based on a determination result of the surrounding environment, when the change in the surrounding environment is detected; and switching the setting related to the automatic correction, when the imaging device has already started capturing a moving image at a point when the change in the surrounding environment is detected, without switching the operational setting.

The above and other objects, features, advantages and technical and industrial significance of embodiments will be better understood by reading the following detailed description of presently preferred embodiments, when considered in connection with the accompanying drawings.

### BRIEF DESCRIPTION OF THE DRAWINGS

FIG. 1 is a block diagram illustrating a functional configuration of a smartphone according to some embodiments;

FIG. 2 is an exemplary diagram illustrating a user interface according to some embodiments;

FIG. 3 is an exemplary diagram illustrating a user interface according to some embodiments; and

FIG. 4 is a flowchart illustrating the procedure of a process of the smartphone according to some embodiments.

### DETAILED DESCRIPTION OF THE PREFERRED EMBODIMENTS

A plurality of embodiments of an electronic device, a control method, and a control program according to the present application are described in detail with reference to the drawings. The following description uses a smartphone as an example of an electronic device according to the present application.

### Embodiments

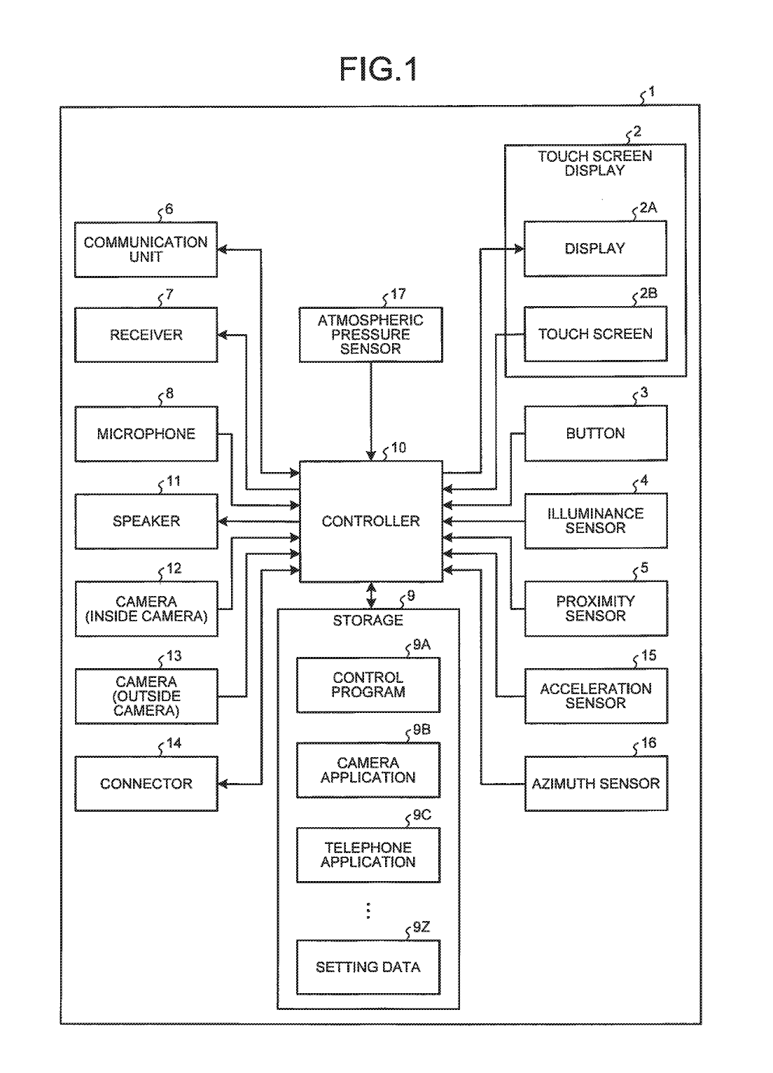

An example of a functional configuration of a smartphone 1 according to some embodiments is described with reference to FIG. 1. FIG. 1 is a block diagram illustrating the functional configuration of a smartphone according to some embodiments. In the following description, the same reference signs may be assigned to the same components. Redundant descriptions may be omitted.

As illustrated in FIG. 1, the smartphone 1 includes a touch screen display 2, a button 3, an illuminance sensor 4, a proximity sensor 5, a communication unit 6, a receiver 7, a microphone 8, a storage 9, a controller 10, a speaker 11, a camera 12, another camera 13, a connector 14, an acceleration sensor 15, an azimuth sensor 16, and an atmospheric pressure sensor 17. In the following description, a device referred to as “the own device” corresponds to the smartphone 1, and a component simply referred to as “the camera” corresponds to the camera 12 or the camera 13.

The touch screen display 2 includes a display 2A and a touch screen 2B. The display 2A and the touch screen 2B may be, for example, arranged with one on top of the other, arranged side by side, or arranged apart from each other. When the display 2A and the touch screen 2B are arranged with one on top of the other, the touch screen display 2 may have one or more sides of the display 2A, for example, not extending along any side of the touch screen 2B. The touch screen display 2 is an example of a display.

The display 2A is provided with a display device such as a liquid crystal display (LCD), an organic electro-luminescence display (OELD), or an inorganic electro-luminescence display (IELD). The display 2A can display characters, images, symbols, patterns, or the like. Screens containing characters, images, symbols, patterns, or the like to be displayed by the display 2A include: a screen called a lock screen; a screen called a home screen; and an application screen to be displayed when an application is running. The home screen may be also called a desktop, a standby screen, an idle screen, a default screen, an application list screen, or a launcher screen. The display 2A is an example of the display.

The touch screen 2B detects a contact of a finger, a pen, a stylus pen, or the like on the touch screen 2B. The touch screen 2B can detect positions (hereinafter, referred to as contact positions) of a plurality of fingers, pens, stylus pens, or the like (hereinafter, simply referred to as “finger”) on the touch screen 2B (touch screen display 2), when the finger comes into contact with the touch screen 2B. The touch screen 2B notifies the controller 10 of the contact of the finger on the touch screen 2B as well as the contact positions. The touch screen 2B is an example of a detecting module and an operation part. In some embodiments, the touch screen 2B measures information that is used to detect a change in a surrounding environment of the own device. When an electrostatic capacity method is adopted as the detection method, for example, the touch screen 2B can detect the change in the electrostatic capacity, as the information that is used to detect the change in the surrounding environment of the own device. The touch screen 2B is an example of a sensor. When a resistive film method or a load detection method is adopted as another detection method, for example, the touch screen 2B may detect the change in the magnitude of the voltage, as the information to determine whether the own device is underwater. When a surface acoustic wave method is adopted as another detection method, for example, the touch screen 2B may detect the attenuation of the surface acoustic wave transmitted from the own device, as the information to determine whether the own device is underwater. When an infrared ray method is adopted as another detection method, for example, the touch screen 2B may detect the attenuation of the infrared light transmitted from the own device, as the information to determine whether the own device is underwater.

A detection method employed by the touch screen 2B is not limited exclusively to the capacitance method, and may be any desired method such as the resistive film method, the load detection method, the surface acoustic wave method, or the infrared method.

The controller 10 (the smartphone 1) determines a type of a gesture, based on at least one of: a contact detected by the touch screen 2B; a position at which the contact has been detected; a change in position at which the contact has been detected; an interval between detection of contacts; and the number of times that a contact has been detected. The gesture is an operation performed on the touch screen 2B (the touch screen display 2) with a finger. Examples of a gesture that the controller 10 (the smartphone 1) determines via the touch screen 2B include but are not limited to touching, long touching, releasing, swiping, tapping, double-tapping, dragging, flicking, pinching in, and pinching out.

The button 3 receives an operational input from a user. The number of buttons 3 may be one or more than one. The button 3 is an example operation button.

The illuminance sensor 4 detects illuminance levels. An illuminance level is a value of a light flux incident to a unit area of a measurement surface of the illuminance sensor 4. The illuminance sensor 4 is used for, for example, adjustment of the luminance of the display 2A.

The proximity sensor 5 detects the presence of a nearby object without making contact therewith. The proximity sensor 5 detects the presence of an object, based on a change in magnetic field, a change in return time of reflected waves of ultrasound waves, or the like. The proximity sensor 5 detects, for example, approaching of a face to the display 2A. The illuminance sensor 4 and the proximity sensor 5 may be configured as a single sensor. The illuminance sensor 4 may be used as a proximity sensor.

The communication unit 6 wirelessly communicates. Examples of a wireless communication standard supported by the communication unit 6 may include, for example, communication standards for cellular phones such as 2G, 3G, and 4G, and communication standards for short range communication. Examples of a communication standard for cellular phones may include, for example, Long Term Evolution (LTE), Wideband Code Division Multiple Access (W-CDMA), Worldwide Interoperability for Microwave Access (WiMAX (registered trademark)), Code Division Multiple Access (CDMA) 2000, Personal Digital Cellular (PDC), Global System for Mobile Communications (GSM (registered trademark)), and Personal Handy-phone System (PHS). Examples of a communication standard for short range communication may include, for example, IEEE802.11, Bluetooth (registered trademark), Infrared Data Association (IrDA), Near Field Communication (NFC), and Wireless Personal Area Network (WPAN). Examples of a WPAN communication standard may include ZigBee (registered trademark). The communication unit 6 may support one or more of the communication standards listed above.

The receiver 7 is a sound output module. The receiver 7 outputs, as sound, sound signals transmitted from the controller 10. The receiver 7 is capable of, for example, outputting the sound of a video and the sound of music reproduced on the smartphone 1 and the voice of a partner on calling. The microphone 8 is a sound input module, and converts the voice of a user and the like into sound signals to be transmitted to the controller 10.

The storage 9 stores therein a computer program and data. The storage 9 is utilized also as a work area that temporarily stores results of processes executed by the controller 10. The storage 9 may include any desirable non-transitory storage medium such as a semiconductor storage medium and a magnetic storage medium. The storage 9 may include a plurality of kinds of storage medium. The storage 9 may include a combination of a storage medium (such as a memory card, an optical disc, or a magneto optical disk) and a storage medium reader. The storage 9 may include a storage device such as a random access memory (RAM) that is utilized as a temporary storage area.

Computer programs stored in the storage 9 include applications to be executed in the foreground or in the background, and a control program (the illustration of which is omitted) that supports the operation of the applications. An application displays screens relating to the application on the display 2A when being executed in the foreground, for example. Examples of the control program include an operating system (OS). A computer program may be installed into the storage 9 via wireless communication using the communication unit 6 or via the non-transitory storage medium.

The storage 9 stores therein, for example, a control program 9A, a camera application 9B, a telephone application 9C, and setting data 9Z. The control program 9A cooperates with the camera application 9B, in order to provide various functions.

The touch screen 2B measures information to be used for detecting a change in the surrounding environment of the own device. In some embodiments, the control program 9A continuously determines the surrounding environment based on the measurement result of the touch screen 2B. In some embodiments, the control program 9A periodically determines the surrounding environment based on the measurement result of the touch screen 2B. The control program 9A detects the change in the surrounding environment based on the determination result of the surrounding environment. If the change in the surrounding environment is detected, the control program 9A provides a function of switching the operational setting related to an operation of the camera, and the setting related to automatic correction of an image obtained by the camera based on the surrounding environment changed. The control program 9A provides the switching function by cooperating with the camera application 9B. More specifically, the control program 9A provides a function of detecting a specific change, when the surrounding environment of the own device has changed to underwater, based on the electrostatic capacity measured by the touch screen 2B. Underwater, the capacitance measured by the touch screen 2B is in a state in which capacitance values at individual contact points on the touch screen 2B show a distribution of being uniform around a certain constant value. Thus, by detecting this uniform distribution, the controller 10 that executes the control program 9A can detect that the surrounding environment of the own device has changed to underwater from other than underwater. In contrast, the controller 10 executing the control program 9A is thus capable of detecting determining that the environment surrounding the own device has changed from underwater to other than underwater by detecting other distribution than the distribution. If the surrounding environment of the own device is underwater, the controller 10 that executes the control program 9A switches the operational setting of the camera as well as the setting related to the automatic correction, to the setting corresponding to underwater. If the surrounding environment of the own device is other than underwater, the controller 10 that executes the control program 9A switches the operational setting of the camera as well as the setting related to the automatic correction, to the setting corresponding to other than underwater.

The atmospheric pressure sensor 17 measures information that is used to detect the change in the surrounding environment of the own device. In some embodiments, the control program 9A continuously determines the surrounding environment based on the measurement result of the atmospheric pressure sensor 17. In some embodiments, the control program 9A periodically determines the surrounding environment based on the measurement result of the atmospheric pressure sensor 17. The control program 9A detects the change in the surrounding environment based on the determination result of the surrounding environment. Upon detecting the change in the surrounding environment, the control program 9A provides a function of switching the operational setting related to the operation of the camera as well as the setting related to the automatic correction of an image obtained by the camera based on the surrounding environment changed. By cooperating with the camera application 9B, the control program 9A provides the switching function. More specifically, the control program 9A provides a function of detecting a specific change when the surrounding environment of the own device has changed to underwater based on the change in an atmospheric pressure value measured by the atmospheric pressure sensor 17. Atmospheric pressure values measured by the atmospheric pressure sensor 17 show a sharply increasing change when the own device falls into water. Thus, by detecting the presence of such a change, the control program 9A can detect the change in the surrounding environment of the own device, to underwater from other than underwater, and the change in the surrounding environment of the own device to other than underwater from underwater. In the following explanation, for the sake of convenience, a situation when the surrounding environment of the own device is other than underwater is suitably referred to as a “first environment”, and a situation when the surrounding environment of the own device is underwater is suitably referred to as a “second environment”.

While detecting the change in the surrounding environment of the own device, the control program 9A may take both the determination result based on the touch screen 2B and the determination result based on the atmospheric pressure sensor 17 into consideration. In some embodiments, for example, if the determination result that the surrounding environment of the own device has changed from the first environment to the second environment, is obtained from at least one of the determination result based on the touch screen 2B and the determination result based on the atmospheric pressure sensor 17, the control program 9A executes a process of confirming the determination result that the surrounding environment of the own device has changed to the second environment. If the determination result that the surrounding environment of the own device has changed from the first environment to the second environment, is obtained from both of the determination result based on the touch screen 2B as well as the determination result based on the atmospheric pressure sensor 17, the control program 9A may execute a process of confirming the determination result that the surrounding environment of the own device has changed to the second environment. If the determination result based on the touch screen 2B differs from the determination result based on the atmospheric pressure sensor 17, the control program 9A may execute a process of confirming the change in the surrounding environment of the own device based on the touch screen 2B preferentially.

If the camera has already started capturing moving images at the point when the change in the surrounding environment of the own device is detected, the control program 9A provides a function of switching the setting related to the automatic correction of an image obtained by the camera, without switching the operational setting of the camera. If the camera finished capturing the moving images, the control program 9A provides a function of switching the operational setting described above as well as the setting related to the automatic correction described above, based on the determination result of the surrounding environment of the own device, at the point when the capturing of the moving images is finished. The following process is implemented when the controller 10 executes the control program 9A that provides such a function. In other words, for example, if the own device is immersed underwater after the capturing of moving images has started, the control program 9A switches the settings related to the automatic correction of the moving images to the underwater setting, without changing the operational setting of the camera to the underwater setting. When the capturing of moving images is finished, the control program 9A switches the operational setting of the camera as well as the setting related to the automatic correction based on the surrounding environment changed.

By cooperating with the camera application 9B, the control program 9A provides a function of displaying a first user interface to operate the camera on the display 2A, when the surrounding environment of the own device is the first environment, and displaying a second user interface to operate the camera on the display 2A, when the surrounding environment of the own device is the second environment. By cooperating with the camera application 9B, the control program 9A may provide a function of at least partially differentiating a display mode of the first user interface from a display mode of the second user interface. In some embodiments, by cooperating with the camera application 9B, the control program 9A may provide a function of differentiating an assignment relation of the functions in which each of the functions for operation that is included in the operational setting and that corresponds to an operation performed via the first user interface, is individually assigned to the button 3, from an assignment relation of the functions in which each of the functions for operation that is included in the operational setting and that corresponds to an operation performed via the second user interface, is individually assigned to the button 3. In other words, the control program 9A may provide a function of at least partially differentiating the functions assigned to the button 3 on the first user interface from the functions assigned to the button 3 on the second user interface.

The camera application 9B provides functions for capturing images as still images and moving images, editing and managing images, and the like. In some embodiments, the camera application 9B provides the first user interface and the second user interface. The camera application 9B provides a plurality of operational functions for operating the camera, a function for processing an image obtained by the camera, and the like. The function for processing the image includes a function of automatically correcting the distortion of an image, a function of adjusting the white balance of an image, and the like.

The telephone application 9C provides a telephone call function for telephone calls in wireless communication.

The setting data 9Z includes various data that are used in processes to be executed based on the functions provided by the control program 9A and the like and in processes to be executed based on the functions provided by the camera application 9B. The setting data 9Z includes data to be used for determining whether the own device is underwater. The data to be used for determining whether the own device is underwater includes reference data regarding the distribution of variations in capacitance in water, and reference data regarding changes in atmospheric pressure in water. The setting data 9Z includes data to be used for implementing individual functions of the camera application.

The controller 10 includes an arithmetic processor. Examples of the arithmetic processor include but are not limited to a central processing unit (CPU), a system-on-a-chip (SoC), a micro control unit (MCU), a field-programmable gate array (FPGA), and a coprocessor. The controller 10 integrally controls operation of the smartphone 1, thereby implementing various functions. The controller 10 is an example of a control module.

Specifically, the controller 10 executes commands contained in a computer program stored in the storage 9 while referring as necessary to data stored in the storage 9. The controller 10 then controls the functional modules in accordance with the data and the commands, thereby implementing the various functions. The examples of the functional module include but are not limited to the display 2A, the communication unit 6, the microphone 8, and the speaker 11. The controller 10 may change the control in accordance with a detection result from a detection module. The examples of the detection module include but are not limited to the touch screen 2B, the button 3, the illuminance sensor 4, the proximity sensor 5, the microphone 8, the camera 12, the camera 13, the acceleration sensor 15, the azimuth sensor 16, and the atmospheric pressure sensor 17.

The controller 10 continuously determines the surrounding environment of the own device based on the determination results of the touch screen 2B and the atmospheric pressure sensor 17 that measure information that is used to detect the change in the surrounding environment, by executing the control program 9A. If the change in the surrounding environment is detected based on the measurement results, the controller 10 implements a process of switching the operational setting related to the operation of the camera, as well as the setting related to the automatic correction of an image obtained by the camera, based on the surrounding environment changed. If the camera has already started capturing moving images at the point when the change in the surrounding environment of the own device is detected, the controller 10 implements a process of switching the setting related to the automatic correction of an image obtained by the camera, without switching the operational setting of the camera.

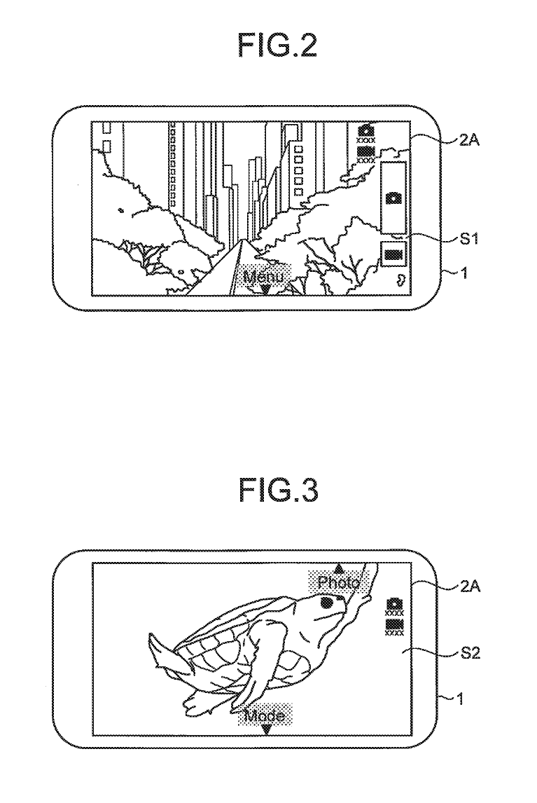

If the surrounding environment of the own device is the first environment, the controller 10 implements a process of displaying the first user interface to operate the camera, on the display 2A, by executing the control program 9A. If the surrounding environment of the own device is the second environment, the controller 10 implements a process of displaying the second user interface to operate the camera, on the display 2A. FIG. 2 and FIG. 3 are exemplary diagrams each illustrating a user interface according to some embodiments. At least a part of display modes such as characters, icons, and the like displayed on the display 2A is different between a first user interface S1 and a second user interface S2. At least a part of functions assigned to the button 3 on each of the user interfaces, is different between the first user interface S1 and the second user interface S2. If the surrounding environment of the own device is other than underwater, as illustrated in FIG. 2, the controller 10 displays the first user interface S1 that corresponds to other than underwater, on the display 2A. The arrow illustrated under the “Menu” on the first user interface S1 in FIG. 2 indicates that the button 3 provided at the location corresponding to the arrow is the button for displaying the menu screen of the camera on the display 2A. If the surrounding environment of the own device is underwater, as illustrated in FIG. 3, the controller 10 displays the second user interface S2 that corresponds to underwater, on the display 2A. The arrow illustrated under the “Mode” on the second user interface S2 illustrated in FIG. 3 indicates that the button 3 provided at the location corresponding to the arrow is the button for displaying the setting screen of the camera, on the display 2A. The controller 10 can also differentiate an assignment relation of the functions in which each of the functions for operation that is included in the operational setting and that corresponds to the operation performed via the first user interface S1, is individually assigned to the button 3, from an assignment relation of the functions in which each of the functions for operation that is included in the operational setting and that corresponds to the operation performed via the second user interface S2, is individually assigned to the button 3. In other words, the button 3 provided at the location corresponding to the arrow indicated by the “Menu” on the first user interface S1 illustrated in FIG. 2, and the button 3 provided at the location corresponding to the arrow indicated by the “Mode” on the second user interface S2 are each assigned with a different function. The button 3 provided at the location corresponding to the arrow indicated by “Photo” on the second user interface S2 is assigned with the function assigned on the first user interface S1.

The speaker 11 is a sound output module. The speaker 11 outputs, as sound, sound signals transmitted from the controller 10. The speaker 11 is capable of outputting, for example, a ringtone and music. One of the receiver 7 and the speaker 11 may functionally double as the other.

The camera 12 and the camera 13 convert captured images into electric signals. The camera 12 is an inside camera that captures an image of an object that faces the display 2A. The camera 13 is an outside camera that captures an image of an object that faces the opposite surface of the display 2A. The camera 12 and the camera 13 may be mounted on the smartphone 1 in a functionally and physically integrated state as a camera unit in which the inside camera and the outside camera can be switched from one to the other so that one of them can be used.

The connector 14 is a terminal to which another apparatus is connected. The connector 14 may be a universal terminal such as a universal serial bus (USB), a high-definition multimedia interface (HDMI (registered trademark)), Light Peak (Thunderbolt (registered trademark)), or an earphone/microphone connector. The connector 14 may be a specialized connector such as a Dock connector. Examples of an apparatus to be connected to the connector 14 include but are not limited to an external storage, a speaker, and a communication apparatus.

The acceleration sensor 15 detects an acceleration direction and a magnitude acting on the smartphone 1. The azimuth sensor 16 detects for example a geomagnetic direction, and detects a direction (azimuth) of the smartphone 1 based on the geomagnetic direction. The atmospheric pressure sensor 17 detects pressure acting on the smartphone 1. The atmospheric pressure sensor 17 is an example of the sensor.

The smartphone 1 may include a GPS receiver and a vibrator in addition to the above individual functional modules. The GPS receiver receives radio signals in a certain frequency band from GPS satellites, demodulates the radio signals thus received, and transmits the demodulated signals to the controller 10, thereby supporting arithmetic processing to find the current location of the smartphone 1. The vibrator vibrates a part or the entirety of the smartphone 1. The vibrator includes, for example, a piezoelectric element or an eccentric motor so as to generate vibration. Although not illustrated in FIG. 1, a functional module such as a battery that is inevitably used to maintain the functions of the smartphone 1, and a control module that is inevitably used to implement control of the smartphone 1 are mounted on the smartphone 1.

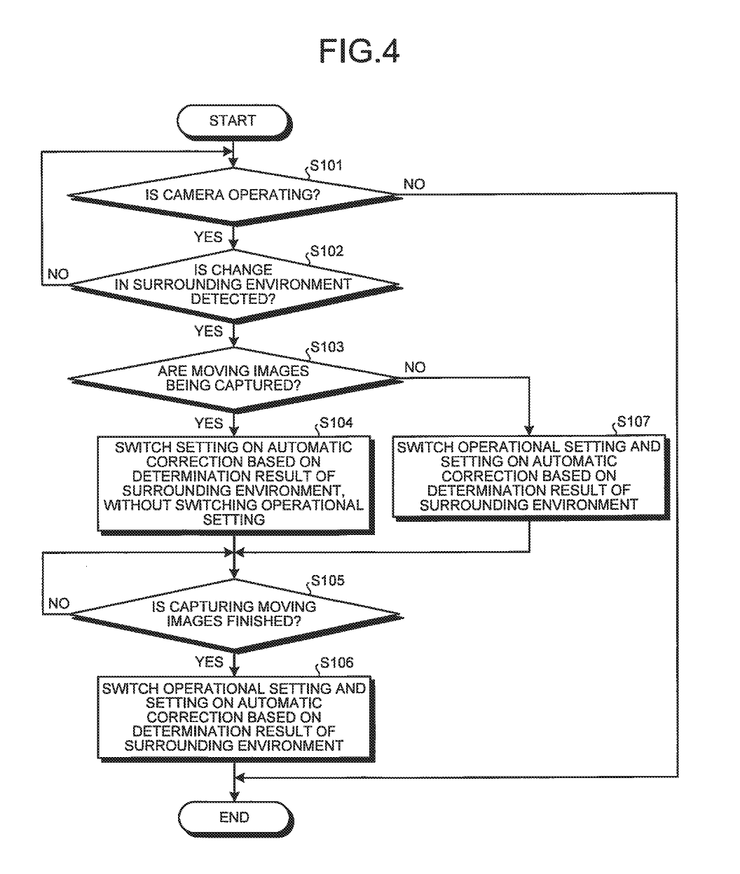

With reference to FIG. 4, a procedures of processes to be executed by the smartphone 1 according to some embodiments are described. FIG. 4 is a flowchart illustrating the procedure of a process according to some embodiments. The process illustrated in FIG. 4 is implemented when the controller 10 executes the control program 9A stored in the storage 9.

As illustrated in FIG. 4, the controller 10 determines whether the camera is operating, at Step S101.

As a result of the determination, if the camera is operating (Yes at Step S101), the controller 10 determines whether a change in the surrounding environment of the own device is detected, at Step S102.

As a result of the determination, if the change in the surrounding environment of the own device is not detected (No at Step S102), the controller 10 returns to the determination at Step S101 described above.

As a result of the determination, if the change in the surrounding environment of the own device is detected (Yes at Step S102), the controller 10 determines whether moving images are being captured, at Step S103.

As a result of the determination, if the moving images are being captured (Yes at Step S103), the controller 10 switches the setting related to the automatic correction of the moving images that are being captured based on the determination result of the surrounding environment of the own device, without changing the operational setting of the camera to the underwater setting, at Step S104.

Subsequently, the controller 10 determines whether the capturing of moving images is finished, at Step S105.

As a result of the determination, if the capturing of moving images is not finished (No at Step S105), the controller 10 repeats the determination at Step S105.

As a result of the determination, if the capturing of moving images is finished (Yes at Step S105), the controller 10 switches the operational setting of the camera as well as the setting related to the automatic correction, based on the surrounding environment changed, at Step S106, and finishes the process illustrated in FIG. 4.

As a result of the determination, if the moving images are not being captured at Step S103 described above (No at Step S103), the controller 10 switches the operational setting of the camera as well as the setting related to the automatic correction based on the surrounding environment changed, at Step S107, and proceeds to the processing procedure at Step S105 described above.

As a result of the determination, if the camera is not operating at Step S101 described above (No at Step S101), the controller 10 finishes the process illustrated in FIG. 4.

In the embodiments described above, if the capturing of moving images has started at the point when the change in the surrounding environment of the own device is detected, the smartphone 1 switches the setting related to the automatic correction of the moving images, without switching the operational setting of the camera. Thus, the user of the smartphone 1 can avoid a situation in which the user interface is suddenly switched due to the change in the surrounding environment of the own device, while the moving images are being captured. Consequently, according to the embodiments described above, it is possible to implement a highly convenient switching control.

The processes described as embodiments are also applicable to other electronic devices expected to have operations performed thereon in water as well as to the smartphone 1.

In order to completely and clearly disclose the techniques according to the appended claims, characteristic embodiments have been described. However, embodiments are not intended to limit the appended claims. The appended claims are embodied by all modifications and alternative configurations that can be invented by those skilled in the art within the scope of the basic teaching set forth herein.

Although the embodiments have been described for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electronic device, comprising:
an imaging device;
a display configured to display an image acquired by the imaging device;
a sensor configured to measure information that is used to detect a change in a surrounding environment of the electronic device; and
at least one controller configured to determine the surrounding environment continuously based on a measurement result of the sensor to switch an operational setting related to an operation of the imaging device and a setting related to automatic correction of the image acquired by the imaging device, based on a determination result of the surrounding environment, when the change in the surrounding environment is detected, wherein
the at least one controller is configured to switch the setting related to the automatic correction, when the imaging device has already started capturing a moving image at a point when the change in the surrounding environment is detected, without switching the operational setting.

2. The electronic device according to claim 1, wherein the at least one controller is configured to switch the operational setting and the setting related to the automatic correction, based on the determination result of the surrounding environment at a point when the capturing of the moving image is finished, when the imaging device finishes capturing the moving image.

3. The electronic device according to claim 2, wherein
the at least one controller is configured to determine whether the surrounding environment is underwater, and
when the surrounding environment is other than underwater, the at least one controller is configured to display a first user interface to operate the imaging device, on the display, and
when the surrounding environment is underwater, the at least one controller is configured to display a second user interface to operate the imaging device, on the display.

4. The electronic device according to claim 3, wherein the at least one controller is configured to differentiate a display mode of the first user interface from a display mode of the second interface.

5. The electronic device according to claim 3, further comprising
a plurality of operation buttons configured to operate the imaging device via the first user interface and the second user interface, wherein
the at least one controller is configured to differentiate an assignment relation of functions in which each of a plurality of the functions for operation that is included in the operational setting and that corresponds to an operation performed via the first user interface, is individually assigned to the operation buttons, from another assignment relation of functions in which each of a plurality of the functions for operation that is included in the operational setting and that corresponds to an operation performed via the second user interface, is individually assigned to the operation buttons.

6. The electronic device according to claim 1, wherein the sensor includes at least one of a touch screen and an atmospheric pressure sensor.

7. A control method executed by an electronic device including an imaging device, a display configured to display an image acquired by the imaging device, and a sensor configured to measure information that is used to detect a change in a surrounding environment of the electronic device, the control method comprising:
determining the surrounding environment continuously based on a measurement result of the sensor to switch an operational setting related to an operation of the imaging device and a setting related to automatic correction of the image acquired by the imaging device, based on a determination result of the surrounding environment, when the change in the surrounding environment is detected; and
switching the setting related to the automatic correction, when the imaging device has already started capturing a moving image at a point when the change in the surrounding environment is detected, without switching the operational setting.

8. A non-transitory storage medium that stores a control program for causing, when executed by an electronic device including an imaging device, a display configured to display an image acquired by the imaging device, and a sensor configured to measure information that is used to detect a change in a surrounding environment of the electronic device, the electronic device to execute:
determining the surrounding environment continuously based on a measurement result of the sensor to switch an operational setting related to an operation of the imaging device and a setting related to automatic correction of the image acquired by the imaging device, based on a determination result of the surrounding environment, when the change in the surrounding environment is detected; and
switching the setting related to the automatic correction, when the imaging device has already started capturing a moving image at a point when the change in the surrounding environment is detected, without switching the operational setting.
